(19) United States
(12) Patent Application Publication
(10) Pub. No.: US 2020/0037132 A1
(43) Pub. Date: Jan. 30, 2020

(54) METHODS AND APPARATUS FOR PEER UE SEARCH AND NOTIFICATION FOR UNICAST OVER SIDELINK

(71) Applicant: QUALCOMM Incorporated, San Diego, CA (US)

(72) Inventors: Zhibin WU, Sunnyvale, CA (US); Hong CHENG, Bridgewater, NJ (US); Kapil GULATI, Hillsborough, NJ (US); Sudhir Kumar BAGHEL, Hillsborough, NJ (US); Shailesh PATIL, San Diego, CA (US)

(21) Appl. No.: 16/522,288

(22) Filed: Jul. 25, 2019

Related U.S. Application Data
(60) Provisional application No. 62/711,278, filed on Jul. 27, 2018.

(51) Int. Cl. H04W 4/46; H04W 64/00; H04W 72/14

(52) U.S. Cl. CPC H04W 4/46; H04W 72/14; H04W 64/00

(57) ABSTRACT

An aspect of the present disclosure includes methods, systems, and computer-readable media for transmitting a first message including sidelink information and location information of a peer UE, receiving a second message including radio resource control information, transmitting a buffer status report, receiving a grant for one or more resources in response to the buffer status report after a successful peer UE search, and transmitting a vehicle-to-vehicle message to the peer UE via the one or more resources.

### CROSS REFERENCE TO RELATED APPLICATION

The present application claims priority to U.S. Provisional Application No. 62/711,278, filed on Jul. 27, 2018, entitled “Methods and Apparatus for Peer UE Search And Notification For Unicast Over Sidelink,” the contents of which are incorporated by reference in their entireties.

### BACKGROUND

Aspects of the present disclosure relate generally to wireless communication networks, and more particularly, to apparatus and methods for vehicle-to-vehicle (V2V) communication.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

When utilizing V2V communication, a user equipment (UE) may communicate directly with other UEs via NR wireless communication technology. The radio resources used by the UEs may be allocated by a NR base station (BS), also known as a gNB. However, if the transmitting UE and the receiving UE are located in different cell coverages, conflicts and collisions among the UEs and their allocated resources may occur. Therefore, improvements in V2V communication may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods for transmitting a first message including sidelink information and location information of a peer UE, receiving a second message including radio resource control information, transmitting a buffer status report, receiving a grant for one or more resources in response to the buffer status report after a successful peer UE search, and transmitting a V2V message to the peer UE via the one or more resources.

Some aspects of the present disclosure include apparatuses having a memory, a transceiver, and one or more processors communicatively coupled with the memory and the transceiver. The one or more processors are configured to perform the steps of transmitting a first message including sidelink information and location information of a peer UE, receiving a second message including radio resource control information, transmitting a buffer status report, receiving a grant for one or more resources in response to the buffer status report after a successful peer UE search, and transmitting a vehicle-to-vehicle message to the peer UE via the one or more resources.

Certain aspects of the present disclosure include a non-transitory computer-readable medium having instructions stored therein that, when executed by one or more processors, cause the one or more processors to perform the steps of transmitting a first message including sidelink information and location information of a peer UE, receiving a second message including radio resource control information, transmitting a buffer status report, receiving a grant for one or more resources in response to the buffer status report after a successful peer UE search, and transmitting a vehicle-to-vehicle message to the peer UE via the one or more resources.

Some aspects of the present disclosure include means for transmitting a first message including sidelink information, means for receiving a second message including radio resource control information, means for transmitting a buffer status report, receiving a grant for one or more resources in response to the buffer status report after a successful peer UE search, and means for transmitting a V2V message to the peer UE via the one or more resources.

Aspects of the present disclosure include methods for receiving a first message including sidelink information from a requesting UE relating to a unicast transmission to a peer UE, transmitting a second message including RRC information to the requesting UE, conducting a peer UE search procedure, receiving a buffer status report from the requesting UE, allocating one or more resources to the requesting UE in response to the buffer status report after completion of the peer UE search procedure, and transmitting a grant for the one or more resources to the requesting UE.

Some aspects of the present disclosure include apparatuses having a memory, a transceiver, and one or more processors communicatively coupled with the memory and the transceiver. The one or more processors are configured to perform the steps of receiving a first message including sidelink UE information from a requesting UE relating to a unicast transmission to a peer UE, transmitting a second message including RRC information to the requesting UE, conducting a peer UE search procedure, receiving a buffer status report from the requesting UE, allocating one or more resources to the requesting UE in response to the buffer status report after completion of the peer UE search procedure, and transmitting a grant for the one or more resources to the requesting UE.

Certain aspects of the present disclosure include a non-transitory computer-readable medium having instructions stored therein that, when executed by one or more processors, cause the one or more processors to perform the steps of receiving a first message including sidelink UE information from a requesting UE relating to a unicast transmission to a peer UE, transmitting a second message including RRC information to the requesting UE, conducting a peer UE search procedure, receiving a buffer status report from the requesting UE, allocating one or more resources to the requesting UE in response to the buffer status report after completion of the peer UE search procedure, and transmitting a grant for the one or more resources to the requesting UE.

Some aspects of the of the present disclosure include means for receiving a first message including sidelink UE information from a requesting UE relating to a unicast transmission to a peer UE, means for transmitting a second message including RRC information to the requesting UE, means for conducting a peer UE search procedure, receiving a buffer status report from the requesting UE, means for allocating one or more resources to the requesting UE in response to the buffer status report after completion of the peer UE search procedure, and means for transmitting a grant for the one or more resources to the requesting UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example of a wireless communication network;

FIG. 2 is a schematic diagram of an example of a user equipment;

FIG. 3 is a schematic diagram of an example of a base station;

FIG. 4 is an example of a wireless communication network where the base station performs the peer UE search within the local coverage area;

FIG. 5 is an example of the wireless communication network of FIG. 4 where the peer UE is outside of the coverage areas of the base station and the neighboring base station;

FIG. 6 is an example of the wireless communication network of FIG. 4 where the base station coordinates with a neighboring base station to perform the peer UE search;

FIG. 7 is an example of a sequence diagram illustrating a base station performing a peer UE search before allocating resources;

FIG. 8 is an example of a sequence diagram illustrating a base station performing a peer UE search after allocating resources;

FIG. 9 is process flow diagram of an example of a method for requesting resources for transmitting a V2V message; and

FIG. 10 is process flow diagram of an example of a method for allocating resources for a V2V message.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout the disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium, such as a computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 902.11 (Wi-Fi), IEEE 902.16 (WiMAX), IEEE 902.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A and/or 5G New Radio (NR) system for purposes of example, and LTE or 5G NR terminology is used in much of the description below, although the techniques are applicable beyond LTE/LTE-A and 5G NR applications, e.g., to other next generation communication systems).

A 5G V2V UE (hereinafter referred to as “UE”) may support both Long Term Evolution (LTE) V2V and NR V2V radio. The network may configure the UE to use Mode 3 operation (i.e., scheduled resource allocation). For NR PC5 Mode 3 operation, three components may be used: radio resource control (RRC) for the sidelink configuration of NR PC5 operation parameters and resources, media access control (MAC), such as buffer status report (BSR) for UE's scheduling request, and downlink control information (DCI-5) to indicate the scheduling assignment (SA) resource locations.

Unicast transmission in a NR V2V network involves two UEs. For Mode 3 operations, it may be advantageous for the network to be aware of the unicast pair's (e.g., transmitting and peer UE) position. If the destination node fails to receive the transmitted data, it may be difficult to recover the information in the data. Half-duplex issue may cause unicast communication failure if one of the UEs is not aware of the radio resource to be used for unicast transmission a priori (e.g., the peer UE is in another cell or out-of-coverage (OoC)). Possibilities of communication failure may include the receiving UE not being tuned to the proper frequency and/or the peer UE is transmitting in the same resource slots/elements as the transmitting UE (i.e., instead of conducting sidelink reception).

For example, UE A and UE B may be under different cell coverage with different radio interface (Uu). UE A may be in cell A and UE B may be in cell B. UE A and UE B may intend to communicate directly via the 5G PC5 (sidelink) interface. In such scenario, there may be no coordination between the 5G base stations (gNBs) of cell A and cell B. Specifically, if UE A and UE B both request Mode 3 operation resource independently, the Xn interface between cell A and cell B may not be used. Each cell may include sidelink receive (SL RX) pools of a neighboring cell in the system information block. Consequently, UE A and UE B may attempt to listen to receive pools of the serving cell and neighboring cells (up to UE capability). A problem may arise because both cells may allocate transmit (TX) resource to UE A and UE B at the same time, and that UE A and UE B or both may not be able to properly receive the unicast transmission due to collision and/or conflict of resources/transmissions.

In some aspects, the radio access network (RAN) may maintain a UE context that keeps a record of layer 2 (L2) identification (ID) used by the peer UE for sidelink communication. The gNB or the LTE base station (eNB) may search the serving cell to see if a particular L2 ID is under the coverage. Base stations (i.e., eNBs and gNBs) may coordinate with each other to detect and eliminate conflict resource scheduling among UEs performing unicast communications. Peer UEs shall not be scheduled to resources for TX (when receiving and transmitting SL transmission at the same time-slot or adjacent time-slots). If two peer UEs are under the same-cell coverage, the conflict resolution may be performed/managed/controlled by the base station of the cell. If two peer UEs are not in the same cell coverage, the conflict resolution may be coordinated by two eNBs/gNBs via X2/Xn interfaces. Optionally, a peer UE may be notified by RAN-initiated paging.

In certain aspects, the network may identify the cell coverage status of the peer UE based on a UE unicast request (using RRC signaling), i.e., Destination (Dst) L2 ID of the peer UE. The RAN searches the neighboring cell(s) to check if the Dst L2 ID is already discovered. If the peer UE is in RRC IDLE status, then there is potentially no discovery because peer UE has not intend to TX anything. If the peer UE is in RRC CONNECTED and has sent the L2 ID to the associated base station, such as a eNB/gNB, then the L2 ID may be associated with this cell. If the L2 ID of the peer UE is not detected by any neighboring cells, the peer UE may be either OoC or in RRC IDLE status. In this case, the network expects no resource allocation conflict, and the source eNB/gNB (i.e., the serving cell of the transmitting UE) may allocate the resource freely to the transmitting UE. Once the destination cell of the peer UE is identified, the source eNB/gNB may notify the destination eNB/gNB about the upcoming scheduled transmission. Optionally, UE-provided location information of peer UE (obtained in sidelink) may be used to help the search.

For example, the peer UE search may be performed after the resource allocation. The serving cell of UE A is triggered to conduct the “peer UE B search,” after completing at least one resource allocation request for UE A. If the search yields no result, UE B may be determined as OoC or in RRC IDLE, and no conflict is expected. If the search yields a cell ID which UE B is under coverage, one of three possibilities may occur. If UE B is in the same cell as UE A, the serving cell may manage the resources to avoid conflict by assigning different resources to UE A and UE B. If UE B is not in the same cell as UE A, the serving cell may utilize inter-eNB/gNB interface to pass information about <L2 ID, resource> so that the neighboring eNB/gNB is aware of the resource allocations. If the UE B is found in RRC INACTIVE status, the serving cell of UE A may request the serving cell of UE B to perform RAN paging to wake up UE B for notification. In some implementations, the serving cell may use inter-eNB/gNB interface to pass information about <L2 ID, resource> regardless of the searching results so the neighboring eNBs/gNBs may keep a record of the resource allocations.

In certain aspects, the peer UE search may be initiated after RRC configuration for unicast is done. While the serving cell of UE A may trigger the “peer UE B search,” the cell may also put the resource allocation on hold, until the peer UE search procedure is completed. If the search yields no result, UE B may be determined as OoC or in RRC IDLE status, and no conflict is foreseen. The serving cell of UE A may continue the resource allocation request for UE A. If the search yields a cell ID which UE B is under coverage of a neighboring cell, one of few actions may be taken. If UE A and UE B are under the same-cell coverage, the conflict resolution may be performed/managed/controlled by the base station of the serving cell. If UE A and UE B are not in the same cell coverage, the conflict resolution may be coordinated by two eNBs/gNBs via X2/Xn interfaces. Optionally, a peer UE may be notified by a RAN-initiated paging.

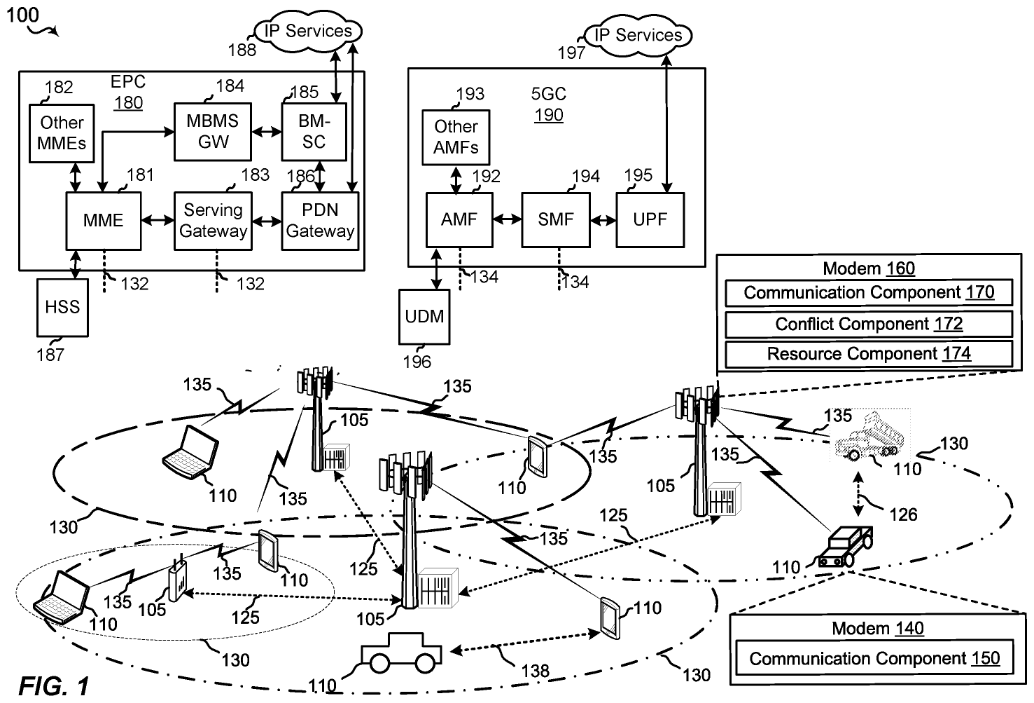

Referring to FIG. 1, in accordance with various aspects of the present disclosure, a wireless communication network 100 includes at least one UE 110 including a modem 140. The modem 140 may include a communication component 150 configured to communicate with the other UEs 110 and/or base stations 105, such as sending/receiving messages to the other UEs 110 and/or base stations 105.

The wireless network may include at least one base station 105 including a modem 160. The modem 160 may include a communication component 170 configured to communicate with one or more UEs 110 and/or one or more other base stations 105, such as sending/receiving messages to the UEs 110 and/or other base stations 105. The modem 160 may include a conflict component 172 that determines the presence or absence of resource conflicts among one or more UEs 110. The modem 160 may include a resource component 174 that allocates resources to the UEs 110.

The modem 160 of a base station 105 may be configured to communicate with one or more other base stations 105 and one or more UEs 110 via a cellular network, a Wi-Fi network, or other wireless and wired networks. The modem 140 of a UE 110 may be configured to communicate with the base stations 105 via a cellular network, a Wi-Fi network, or other wireless and wired networks. The modems 140, 160 may receive and transmit data packets.

The wireless communication network 100 may include one or more base stations 105, one or more UEs 110, and a core network, such as an Evolved Packet Core (EPC) 180 and/or a 5G core (5GC) 190. The EPC 180 and/or the 5GC 190 may provide user authentication, access authorization, tracking, internet protocol (IP) connectivity, and other access, routing, or mobility functions. The base stations 105 configured for 4G LTE (collectively referred to as Evolved Universal Mobile Telecommunications System (UMTS) Terrestrial Radio Access Network (E-UTRAN)) may interface with the EPC 180 through backhaul links 132 (e.g., 51, etc.). The base stations 105 configured for 5G NR (collectively referred to as Next Generation RAN (NG-RAN)) may interface with the 5GC 190 through backhaul links 134. In addition to other functions, the base stations 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 105 may communicate with each other either directly or indirectly (e.g., through the EPC 180 or the 5GC 190), with one another over backhaul links 125, 132, or 134 (e.g., Xn, X1, or X2 interfaces). The backhaul links 125, 132, 134 may be wired or wireless communication links.

The base stations 105 may wirelessly communicate with the UEs 110 via one or more antennas. Each of the base stations 105 may provide communication coverage for a respective geographic coverage area 130. In some examples, the base stations 105 may be referred to as a base station, a radio base station, an access point (AP), an access node, a radio transceiver, a NodeB, eNodeB (eNB), gNodeB (gNB), Home NodeB, a Home eNodeB, a relay, a transceiver function, a basic service set (BSS), an extended service set (ESS), a transmit reception point (TRP), or some other suitable terminology. The geographic coverage area 130 for a base station 105 may be divided into sectors or cells making up only a portion of the coverage area (not shown). The wireless communication network 100 may include base stations 105 of different types (e.g., macro cell base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 130 for different communication technologies.

In some examples, the wireless communication network 100 may be or include one or any combination of communication technologies, including a NR or 5G technology, a LTE or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe the UEs 110. The wireless communication network 100 may be a heterogeneous technology network in which different types of eNBs provide coverage for various geographical regions. For example, each eNB or base station 105 may provide communication coverage for a macro cell, a small cell, or other types of cell.

A macro cell may generally cover a relatively large geographic area (e.g., several kilometers in radius) and may allow unrestricted access by UEs 110 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by UEs 110 with service subscriptions with the network provider. A femto cell may also cover a small geographic area (e.g., a home) and may provide restricted access and/or unrestricted access by UEs 110 having an association with the femto cell (e.g., in the restricted access case, UEs 110 in a closed subscriber group (CSG) of the base station 105, which may include UEs 110 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARQ) to provide retransmission at the MAC layer to improve link efficiency. In the control plane, the RRC protocol layer may provide establishment, configuration, and maintenance of an RRC connection between a UE 110 and the base stations 105. The RRC protocol layer may also be used for the EPC 180 or the 5GC 190 support of radio bearers for the user plane data. At the physical (PHY) layer, the transport channels may be mapped to physical channels.

The UEs 110 may be dispersed throughout the wireless communication network 100, and each UE 110 may be stationary or mobile. A UE 110 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 110 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Some non-limiting examples of UEs 110 may include a session initiation protocol (SIP) phone, a satellite radio, a global positioning system, a multimedia device, a video device, a digital audio player (e.g., MP3 player), a camera, a game console, a smart device, a wearable device, a vehicle, an electric meter, a gas pump, a large or small kitchen appliance, a healthcare device, an implant, a sensor/actuator, a display, or any other similar functioning device. Additionally, a UE 110 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. Some of the UEs 110 may be referred to as IoT devices (e.g., parking meter, gas pump, toaster, vehicles, heart monitor, etc.). A UE 110 may be able to communicate with various types of base stations 105 and network equipment including macro eNBs, small cell eNBs, macro gNBs, small cell gNBs, relay base stations, and the like.

UE 110 may be configured to establish one or more wireless communication links 135 with one or more base stations 105. The wireless communication links 135 shown in wireless communication network 100 may carry uplink (UL) transmissions from a UE 110 to a base station 105, or downlink (DL) transmissions, from a base station 105 to a UE 110. The downlink transmissions may also be called forward link transmissions while the uplink transmissions may also be called reverse link transmissions. Each wireless communication link 135 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 135 may transmit bidirectional communications using FDD (e.g., using paired spectrum resources) or TDD operation (e.g., using unpaired spectrum resources). Frame structures may be defined for FDD (e.g., frame structure type 1) and TDD (e.g., frame structure type 2). Moreover, in some aspects, the wireless communication links 135 may represent one or more broadcast channels.

Certain UEs 110 may communicate with each other using a V2V communication link 126. The V2V communication link 126 may use the DL/UL WWAN spectrum. The V2V communication link 126 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). V2V communication may be through a variety of wireless V2V communications systems, such as for example, FlashLinQ, WiMedia, Bluetooth, ZigBee, Wi-Fi based on the IEEE 802.11 standard, LTE, or NR.

In certain aspects, one or more UEs 110 may be configured for cellular vehicle-to-everything (CV2X) communications between UEs 110. The UEs 110 may include various devices related to vehicles and transportation. For example, the UEs 110 may include vehicles, devices within vehicles, and transportation infrastructure such as roadside devices, tolling stations, fuel supplies, or any other device that that may communicate with a vehicle. A UE 110 may act as either a source device or a destination device for CV2X communication. A source UE 110 may advertise CV2X services supported by the source UE 110. A destination UE 110 may discover CV2X services supported by the source UE 110. Moreover, a UE 110 may act as both a source UE and a destination UE. For example, a vehicle may act as a source to provide speed and braking updates to surrounding vehicles and act as a destination to communicate with a tolling station. Accordingly, a single UE 110 may include both a host discovery component and a client discovery component.

In some aspects of the wireless communication network 100, base stations 105 or UEs 110 may include multiple antennas for employing antenna diversity schemes to improve communication quality and reliability between base stations 105 and UEs 110. Additionally or alternatively, base stations 105 or UEs 110 may employ MIMO techniques that may take advantage of multi-path environments to transmit multiple spatial layers carrying the same or different coded data.

Wireless communication network 100 may support operation on multiple cells or carriers, such as carrier aggregation (CA) or multi-carrier operation. The terms “carrier,” “component carrier,” “cell,” and “channel” may be used interchangeably herein. A UE 110 may be configured with multiple downlink component carriers (CCs) and one or more uplink CCs for carrier aggregation. Carrier aggregation may be used with both FDD and TDD component carriers. The communication links 135 may use multiple-input and multiple-output (MIMO) antenna technology, including spatial multiplexing, beamforming, and/or transmit diversity. The base stations 105 and UEs 110 may use spectrum up to Y MHz (e.g., 5, 10, 15, 20, 30, 50, 100, 200, 400, etc., MHz) bandwidth per carrier allocated in a carrier aggregation of up to a total of Yx MHz (x=number of component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 138. The D2D communication link 138 may use the DL/UL WWAN spectrum. The D2D communication link 138 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications network 100 may further include base stations 105 operating according to Wi-Fi technology, e.g., Wi-Fi access points, in communication with UEs 110 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

The small cell may operate in a licensed and/or an unlicensed frequency spectrum. When operating in an unlicensed frequency spectrum, the small cell may employ NR and use the same 5 GHz unlicensed frequency spectrum as used by the Wi-Fi AP. The small cell, employing NR in an unlicensed frequency spectrum, may boost coverage to and/or increase capacity of the access network.

Some base stations 105, such as a gNB may operate in a traditional sub 6 GHz spectrum, in millimeter wave (mmW) frequencies in communication with the UE 110. When the gNB, such as a base station 105 operates in mmW or near mmW frequencies, the base station 105 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, and may also be referred to as centimeter wave. Communications using the mmW and/or near mmW radio frequency band has extremely high path loss and a short range. The mmW base station 105 may utilize beamforming with the UEs 110 in their transmissions to compensate for the extremely high path loss and short range.

In a non-limiting example, the EPC 180 may include a Mobility Management Entity (MME) 181, other MMEs 182, a Serving Gateway 183, a Multimedia Broadcast Multicast Service (MBMS) Gateway 184, a Broadcast Multicast Service Center (BM-SC) 185, and a Packet Data Network (PDN) Gateway 186. The MME 181 may be in communication with a Home Subscriber Server (HSS) 187. The MME 181 is the control node that processes the signaling between the UEs 110 and the EPC 180. Generally, the MME 181 provides bearer and connection management. All user Internet protocol (IP) packets are transferred through the Serving Gateway 183, which itself is connected to the PDN Gateway 186. The PDN Gateway 186 provides UE IP address allocation as well as other functions. The PDN Gateway 186 and the BM-SC 185 are connected to the IP Services 188. The IP Services 188 may include the Internet, an intranet, an IP Multimedia Subsystem (IMS), a PS Streaming Service, and/or other IP services. The BM-SC 185 may provide functions for MBMS user service provisioning and delivery. The BM-SC 185 may serve as an entry point for content provider MBMS transmission, may be used to authorize and initiate MBMS Bearer Services within a public land mobile network (PLMN), and may be used to schedule MBMS transmissions. The MBMS Gateway 184 may be used to distribute MBMS traffic to the base stations 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

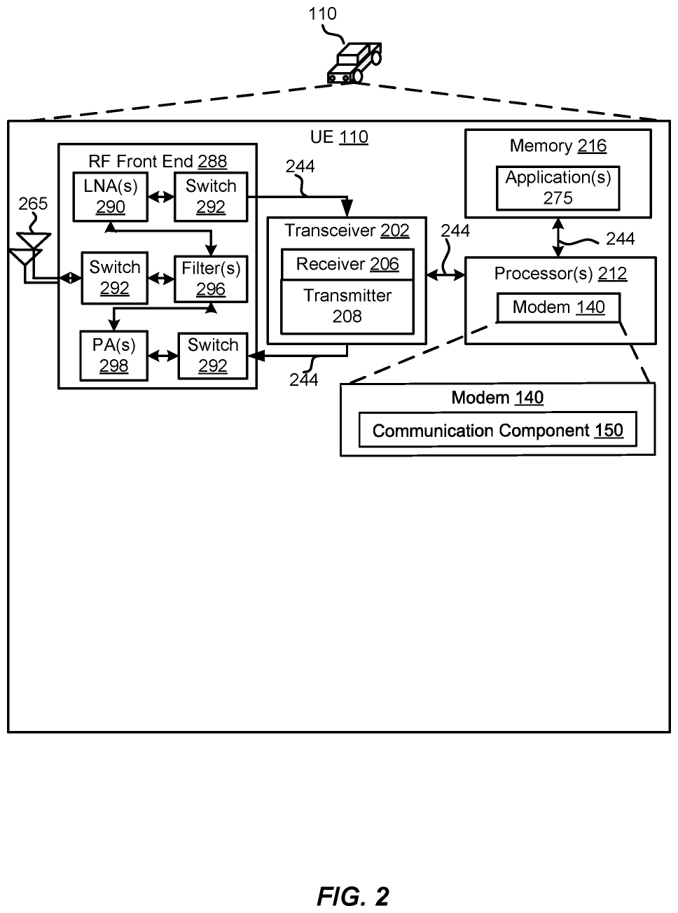

Referring to FIG. 2, one example of an implementation of the UE 110 may include a variety of components, some of which have already been described above, but including components such as one or more processors 212 and memory 216 and transceiver 202 in communication via one or more buses 244, which may operate in conjunction with the modem 140 and the communication component 150 to enable one or more of the functions described herein related to communicating with the base station 105. Further, the one or more processors 212, modem 140, memory 216, transceiver 202, RF front end 288 and one or more antennas 265, may be configured to support voice and/or data calls (simultaneously or non-simultaneously) in one or more radio access technologies. The one or more antennas 265 may include stand-alone antennas and/or antenna arrays.

In an aspect, the one or more processors 212 may include the modem 140 that uses one or more modem processors. The various functions related to the communication component 150 may be included in the modem 140 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or the modem 140 associated with the communication component 150 may be performed by transceiver 202.

Also, memory 216 may be configured to store data used herein and/or local versions of applications 275 for the communication component 150 and/or one or more subcomponents of the communication component 150 being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 150 and/or one or more of the subcomponents, and/or data associated therewith, when UE 110 is operating at least one processor 212 to execute the communication component 150 and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one base station 105 or wireless transmissions transmitted by UE 110. RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more base stations 105 or one or more cells associated with one or more base stations 105. In an aspect, for example, the modem 140 may configure transceiver 202 to operate at a specified frequency and power level based on the UE configuration of the UE 110 and the communication protocol used by the modem 140.

In an aspect, the modem 140 may be a multiband-multimode modem, which may process digital data and communicate with transceiver 202 such that the digital data is sent and received using transceiver 202. In an aspect, the modem 140 may be multiband and be configured to support multiple frequency bands for a specific communications protocol. In an aspect, the modem 140 may be multimode and be configured to support multiple operating networks and communications protocols. In an aspect, the modem 140 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network during cell selection and/or cell reselection.

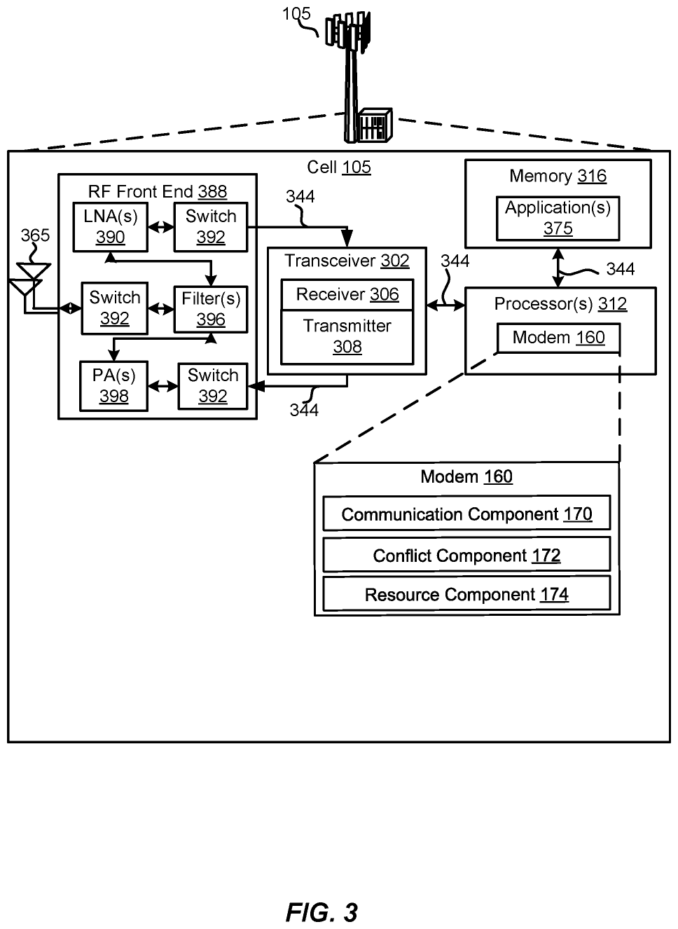

Referring to FIG. 3, one example of an implementation of base station 105 may include a variety of components, some of which have already been described above, but including components such as one or more processors 312 and memory 316 and transceiver 302 in communication via one or more buses 344, which may operate in conjunction with the modem 160, the communication component 170, the conflict component 172, and/or the resource component 174 to enable one or more of the functions described herein related to communicating with the UE 110. Further, the one or more processors 312, modem 160, memory 316, transceiver 302, RF front end 388 and one or more antennas 365, may be configured to support voice and/or data calls (simultaneously or non-simultaneously) in one or more radio access technologies. The one or more antennas 365 may include stand-alone antennas and/or antenna arrays.

In an aspect, the one or more processors 312 may include the modem 160 that uses one or more modem processors. The various functions related to the communication component 170, the communication component 170, the conflict component 172, and/or the resource component 174 may be included in the modem 160 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or the modem 160 associated with the communication component 170 may be performed by transceiver 302.

Also, memory 316 may be configured to store data used herein and/or local versions of applications 375 for the communication component 170, the conflict component 172, and/or the resource component 174 and/or one or more subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 170, the conflict component 172, and/or the resource component 174 and/or one or more of the subcomponents, and/or data associated therewith, when base station 105 is operating at least one processor 312 to execute the communication component 170, the conflict component 172, and/or the resource component 174 and/or one or more of their subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the base station 105 may include RF front end 388, which may operate in communication with one or more antennas 365 and transceiver 302 for receiving and transmitting radio transmissions, for example, wireless communications transmitted by at least one base station 105 or wireless transmissions transmitted by UE 110. RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that base station 105 may communicate with, for example, the UE 110. In an aspect, for example, the modem 160 may configure transceiver 302 to operate at a specified frequency and power level based on the base station configuration of the base station 105 and the communication protocol used by the modem 160.

In an aspect, the modem 160 may be a multiband-multimode modem, which may process digital data and communicate with transceiver 302 such that the digital data is sent and received using transceiver 302. In an aspect, the modem 160 may be multiband and be configured to support multiple frequency bands for a specific communications protocol. In an aspect, the modem 140 may be multimode and be configured to support multiple operating networks and communications protocols. In an aspect, the modem 160 may control one or more components of UE 110 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration information associated with base station 105.

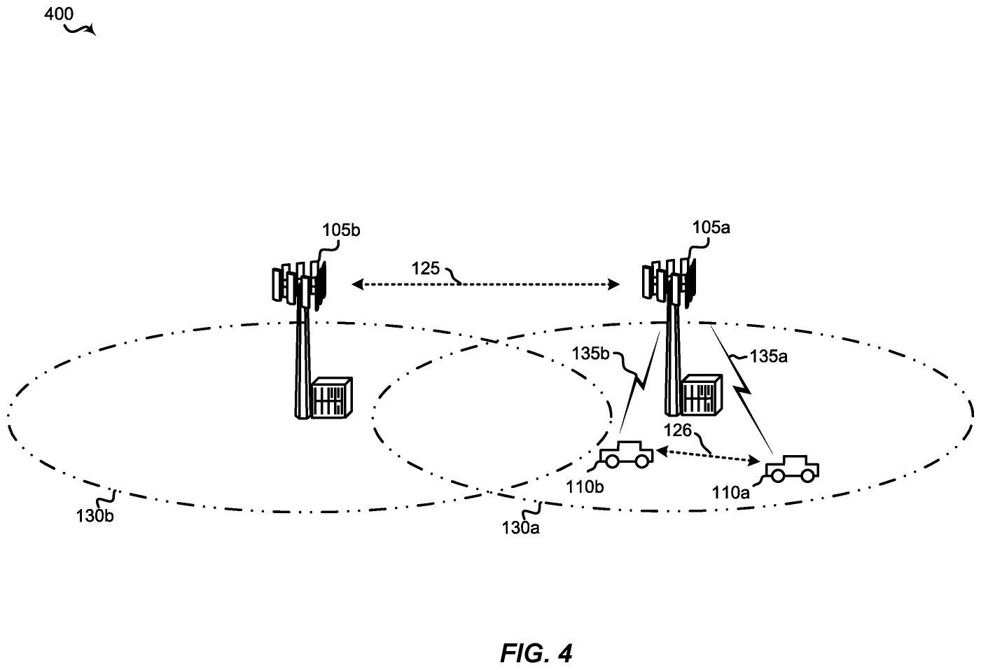

Referring to FIG. 4, an example of an environment 400 for peer UE search in unicast communication may include a first gNB 105a that serves a first cell having a coverage area 130a and a second gNB 105b that serves a second cell having a coverage area 130b. The first gNB 105a may manage a neighboring cell of the first cell, such as the second cell. In some examples, the first cell may include more than one neighboring cell. The first gNB 105a and the second gNB 105b may communicate via a backhaul link such as an Xn interface link 125. In some implementations, a first UE 110a may transmit sidelink UE information to the first gNB 105a (i.e., serving cell) via the first wireless communication link 135a to initiate a V2V communication session with the second UE 110b. The sidelink UE information may include one or more of L2 IDs of the first UE 110a and/or the second UE 110b, a bearer ID indicating the Quality of Service (QoS) for the requested sidelink communication, physical IDs of the first UE 110a and/or the second UE 110b, and/or other identifiers related to the first UE 110a, the second UE 110b, or the sidelink communication. The sidelink UE information may also include a request to establish a V2V communication link 126 with the second UE 110b.

Still referring to FIG. 4, the first gNB 105a may transmit RRC connection reconfiguration information to the first UE 110a in response to the sidelink UE information. The RRC connection reconfiguration information may include configuration details for a sidelink signaling radio bearer, a sidelink data radio bearer, Physical Sidelink Control Channel (PSCCH) information, Physical Sidelink Feedback Channel (PSFCH) information, Physical Sidelink Shared Channel (PSSCH) information, channel quality indicator (CQI) reports, sounding reference signals, antenna configurations, scheduling requests, and other information used by the first UE 110a to establish the V2V communication link 126.

Still referring to FIG. 4, in some implementations, the first gNB 105a may begin a peer UE search procedure prior to allocating first resources to the first UE 110a when the second UE 110b is within the first coverage area 130a of the first gNB 105a. The peer UE search procedure may include searching the cell served by the first gNB 105a for the second UE 110b. Since the second UE 110b is within the first coverage area 130a of the first gNB 105a, the first gNB 105a may reserve the first resources for the first UE 110a and prevent other UEs, such as the second UE 110b, to utilize the first resources. In alternative implementations, if the second UE 110b is idle (i.e., RRC IDLE status), the first gNB 105a may determine that there is no foreseeable conflict when allocating the first resources to the first UE 110a. In certain implementations, if the second UE 110b is inactive (i.e., RRC INACTIVE), the first gNB 105a may transmit a RAN paging signal, using a second wireless communication link 135b, to the second UE 110b to wake up the second UE 110b. After waking the second UE 110b, the first gNB 105a may reserve the first resources for the first UE 110a and prevent other UEs, such as the second UE 110b, to utilize the first resources. In certain implementations, knowing the physical location of the second UE 110b may help the first gNB 105a and/or the second gNB 105a identify the cell location of the second UE 110b.

Still referring to FIG. 4, the first UE 110a may send a BSR to the first gNB 105a to request the first resources. The amount of resource elements in the first resources may be determined by the amount of data in the TX buffer of the first UE 110a, the available resources in the serving cell of the first gNB 105a, the types of data to be transmitted, or other relevant criteria. In response to the BSR, the first gNB 105a may transmit an enhanced physical downlink control channel (ePDCCH) grant to the first UE 110a to allocate the first resources to the first UE 110a. Next, the first UE 110a may transmit a V2V message to the second UE 110b via the V2V communication link 126.

In other examples, the first UE 110a may perform the peer UE search (described above) after allocating the first resources to the first UE 110a in response to the BSR.

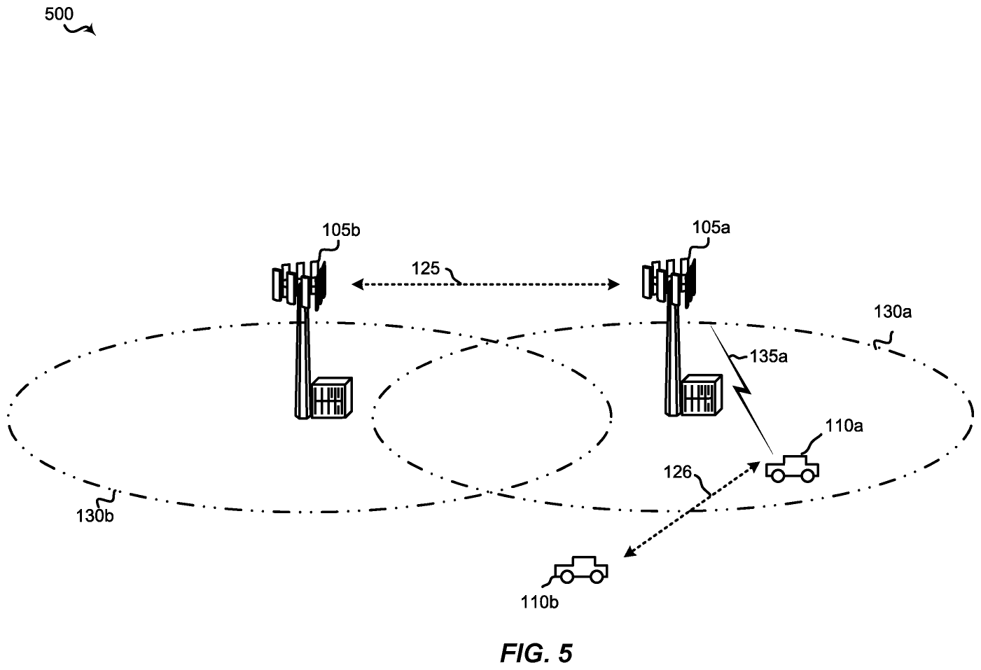

Referring to FIG. 5, another example of an environment 500 for peer UE search in unicast communication may include the second UE 110b being outside the first coverage area 130a and the second coverage area 130b. In some implementations, the first gNB 105a may begin the peer UE search procedure (after the transmission of the RRC connection reconfiguration information described above) prior to allocating the first resources to the first UE 110a when the second UE 110b is outside the first coverage area 130a and the second coverage area 130b. Since the first gNB 105a and the second gNB 105b may not be able to communicate with the second UE 110b, the first gNB 105a may determine that there is no foreseeable conflict when allocating the first resources to the first UE 110a. Next, the first gNB 105a may proceed to allocate the first resources to the first UE 110a as described above.

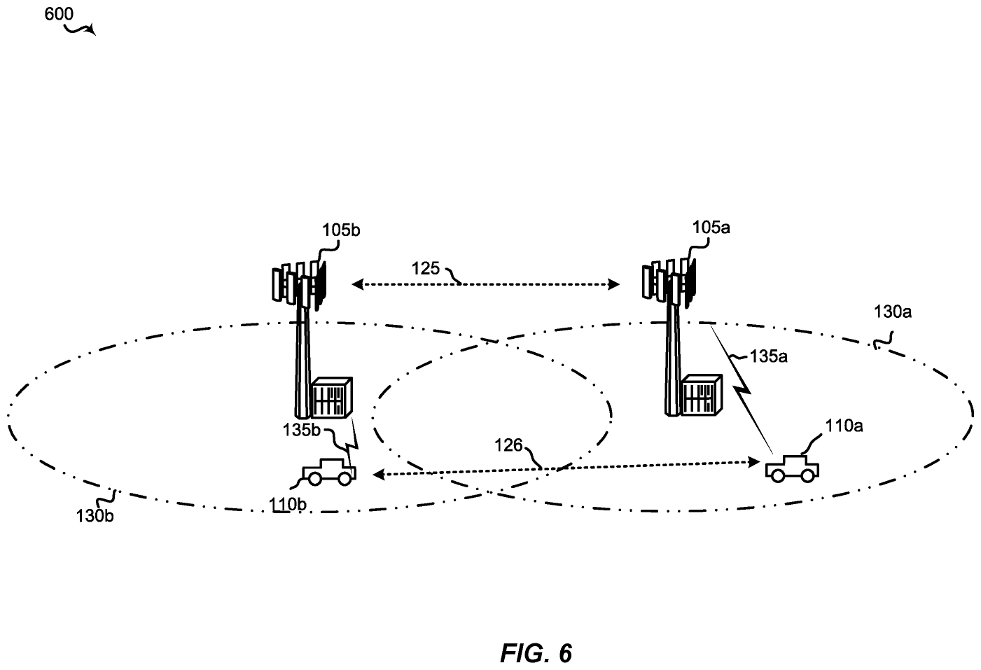

Referring to FIG. 6, another example of an environment 600 for peer UE search in unicast communication may include the second UE 110b being outside the first coverage area 130a and inside the second coverage area 130b. In some implementations, the first gNB 105a may begin the peer UE search procedure (after the transmission of the RRC connection reconfiguration information described above) prior to allocating the first resources to the first UE 110a when the second UE 110b is outside the first coverage area 130a and inside the second coverage area 130b. The peer UE search procedure may begin with searching the cell served by the first gNB 105a for the second UE 110b, and proceeding to neighboring cells, such as the second cell served by the second gNB 105b. The first gNB 105a may coordinate the peer UE search with the second gNB 105b via the Xn interface link 125. Since the second UE 110b is outside the first coverage area 130a and inside the second coverage area 130b, the first gNB 105a may coordinate with the second gNB 105b to reserve the first resources for the first UE 110a and prevent other UEs, such as the second UE 110b, to utilize the first resources within the first coverage area 130a and the second coverage area 130b.

Still referring to FIG. 6, in alternative implementations, if the second UE 110b is idle (i.e., RRC IDLE status), the first gNB 105a and/or the second gNB 105b may determine that there is no foreseeable conflict when allocating the first resources to the first UE 110a. In certain implementations, if the second UE 110b is inactive (i.e., RRC INACTIVE), the second gNB 105b may transmit a RAN paging signal, using a second wireless communication link 135b, to the second UE 110b to wake up the second UE 110b. After waking the second UE 110b, the first gNB 105a may coordinate with the second gNB 105b to reserve the first resources for the first UE 110a and prevent other UEs, such as the second UE 110b, to utilize the first resources within the first coverage area 130a and the second coverage area 130b. Next, the first gNB 105a may proceed to allocate the first resources to the first UE 110a as described above. The first UE 110a may communicate with the second UE 110b via the V2V communication link 126 using the first resources allocated by the first gNB 105a.

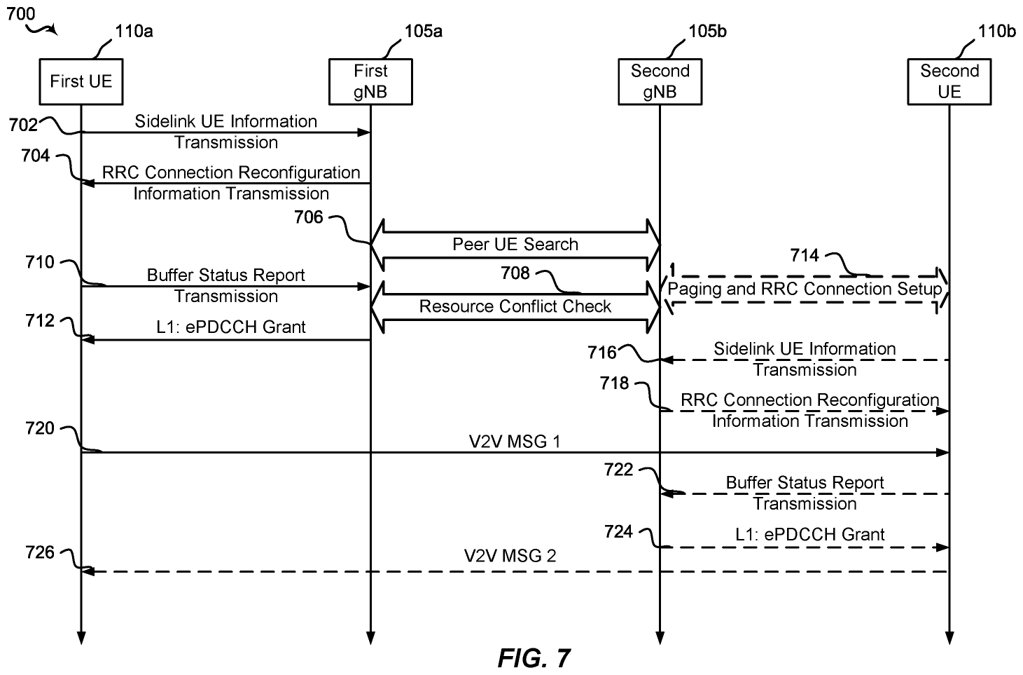

Turning now to FIG. 7, an example of a sequence diagram 700 for a peer UE search in unicast communication includes the first UE 110a in the first cell served by the first gNB 105a and the second UE 110b in the second cell served by the second gNB 105b. In the sequence diagram 700 the resource allocation may occur after the peer UE search and the resource conflict check.

At 702, the first UE 110a may transmit the sidelink UE information to the first gNB 105a. The sidelink UE information may include one or more of L2 IDs of the first UE 110a and/or the second UE 110b, a bearer ID indicating the Quality of Service (QoS) for the requested sidelink communication, physical IDs of the first UE 110a and/or the second UE 110b, and/or other identifiers related to the first UE 110a, the second UE 110b, or the sidelink communication. The sidelink UE information may also include a request to establish a V2V communication link 126 with the second UE 110b.

At 704, the first gNB 105a may transmit the RRC connection reconfiguration information to the first UE 110a. The RRC connection reconfiguration information may include configuration details for a sidelink signaling radio bearer, a sidelink data radio bearer, PSCCH information, PSFCH information, PSSCH information, one or more CQI reports, sounding reference signals, antenna configurations, scheduling requests, and other information used by the first UE 110a to establish the V2V communication link 126.

At 706, the first gNB 105a may conduct the peer UE search procedure (after the transmission of the RRC connection reconfiguration information described above) prior to allocating the first resources to the first UE 110a when the second UE 110b is outside the first coverage area 130a and inside the second coverage area 130b. The peer UE search procedure may begin with searching the cell served by the first gNB 105a for the second UE 110b, and proceeding to neighboring cells, such as the second cell served by the second gNB 105b. The peer UE search may include the first gNB 105a coordinating with the second gNB 105b over the Xn interface link 125 to attempt to locate the second UE 110b.

At 708, the first gNB 105a and the second gNB 105b may perform a resource conflict check. The first gNB 105a may coordinate with the second gNB 105b (over the Xn interface link 125) to reserve the first resources for the first UE 110a and prevent other UEs, such as the second UE 110b, to utilize the first resources within the first coverage area 130a and the second coverage area 130b.

At 710, the first UE 110a may transmit the BSR to the first gNB 105a to request the first resources. The amount of resource elements in the first resources may be determined by the amount of data in the TX buffer of the first UE 110a, the available resources in the serving cell of the gNB 105a, the types of data to be transmitted, or other relevant criteria. The BSR transmission 710 may occur after the RRC connection reconfiguration information transmission 704. In some examples, the BSR transmission may occur before or after the peer UE search 706 and/or the resource conflict check 708.

At 712, the first gNB 105a may transmit the ePDCCH grant to the first UE 110a to allocate the first resources to the first UE 110a. The ePDCCH grant transmission 712 may occur after the resource conflict check 708.

At 714, in optional implementations, if the second UE 110b is inactive (i.e., RRC INACTIVE), the second gNB 105b may page the second UE 110b and transmits RRC connection information to the second UE 110b. In an example, the second gNB 105b may transmit a RAN paging signal, using a second wireless communication link 135b, to the second UE 110b to wake up the second UE 110b. Next, the second gNB 105b may transmit RRC connection information to the second UE 110b so the second UE 110b may join the second cell served by the second gNB 105b.

At 716, in alternative implementations, the second UE 110b may transmit second sidelink UE information to the second gNB 105b via the second wireless communication link 135b. The second sidelink UE information may include one or more of L2 IDs of the first UE 110a and/or the second UE 110b, a bearer ID indicating the Quality of Service (QoS) for the requested sidelink communication, physical IDs of the first UE 110a and/or the second UE 110b, and/or other identifiers related to the first UE 110a, the second UE 110b, or the sidelink communication. The second sidelink UE information may also include a request to establish the V2V communication link 126 with the first UE 110a.

At 718, in optional implementations, the second gNB 105b may transmit second RRC connection reconfiguration information to the second UE 110b in response to the second sidelink UE information. The second RRC connection reconfiguration information may include configuration details for a sidelink signaling radio bearer, a sidelink data radio bearer, PSCCH information, PSFCH information, PSSCH information relating to the second cell, channel quality indicator (CQI) reports, sounding reference signals, antenna configurations, scheduling requests, and other information used by the second UE 110b to establish the V2V communication link 126.

The second UE 110b may be connected to the network via the paging and RRC connection setup 714, the second RRC connection reconfiguration information transmission 718, or other instances.

At 720, the first UE 110a transmits the first V2V message to the second UE 110b via the V2V communication link 126 using the first resources allocated by the first gNB 105a.

At 722, in optional implementations, the second UE 110b may send a second BSR to the second gNB 105b to request second resources. The amount of resource elements in the second resources may be determined by the amount of data in the TX buffer of the second UE 110b, the available resources in the serving cell of the second gNB 105b, the types of data to be transmitted, or other relevant criteria.

At 724, in an optional implementation, in response to the second BSR, the second gNB 105b may transmit a second ePDCCH grant to the second UE 110b to allocate the second resources to the second UE 110b.

At 726, in optional implementations, the second UE 110b may transmit the second V2V message to the first UE 110a via the V2V communication link 126. The second V2V message may be in response to the first V2V message sent by the first UE 110a, or an unrelated message.

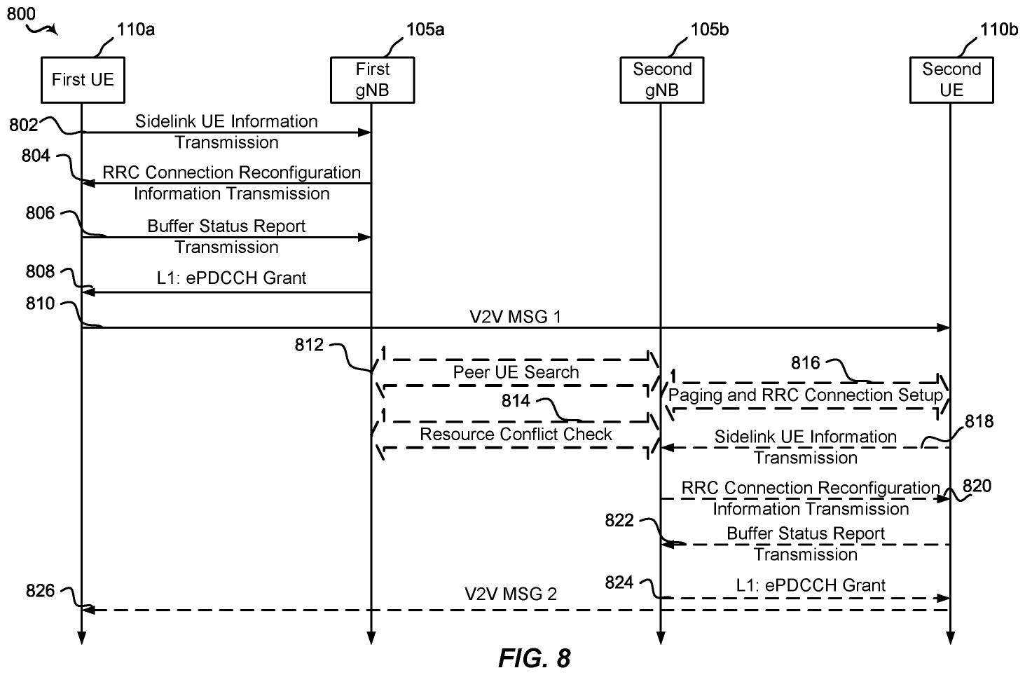

Turning now to FIG. 8, another example of a sequence diagram 800 for a peer UE search in unicast communication includes the first UE 110a in the first cell served by the first gNB 105a and the second UE 110b in the second cell served by the second gNB 105b. In the process flow diagram 800 the resource allocation may occur before the peer UE search and the resource conflict check.

At 802, the first UE 110a may transmit the sidelink UE information to the first gNB 105a. The sidelink UE information may include one or more of L2 IDs of the first UE 110a and/or the second UE 110b, a bearer ID indicating the Quality of Service (QoS) for the requested sidelink communication, physical IDs of the first UE 110a and/or the second UE 110b, and/or other identifiers related to the first UE 110a, the second UE 110b, or the sidelink communication. The sidelink UE information may also include a request to establish a V2V communication link 126 with the second UE 110b.

At 804, the first gNB 105a may transmit the RRC connection reconfiguration information to the first UE 110a. The RRC connection reconfiguration information may include configuration details for a sidelink signaling radio bearer, a sidelink data radio bearer, PSCCH information, PSFCH information, PSSCH information, one or more CQI reports, sounding reference signals, antenna configurations, scheduling requests, and other information used by the first UE 110a to establish the V2V communication link 126.

At 806, the first UE 110a may transmit the BSR to the first gNB 105a to request the first resources. The amount of resource elements in the first resources may be determined by the amount of data in the TX buffer of the first UE 110a, the available resources in the serving cell of the gNB 105a, the types of data to be transmitted, or other relevant criteria.

At 808, the first gNB 105a may transmit the ePDCCH grant to the first UE 110a to allocate the first resources to the first UE 110a.

At 810, the first UE 110a transmits the first V2V message to the second UE 110b via the V2V communication link 126 using the first resources allocated by the first gNB 105a.

Still referring to FIG. 8, in optional implementations, at 812, the first gNB 105a may conduct the peer UE search procedure after allocating the first resources to the first UE 110a when the second UE 110b is outside the first coverage area 130a and inside the second coverage area 130b. The peer UE search procedure may begin with searching the cell served by the first gNB 105a for the second UE 110b, and proceeding to neighboring cells, such as the second cell served by the second gNB 105b. The peer UE search may include the first gNB 105a coordinating with the second gNB 105b over the Xn interface link 125 to attempt to locate the second UE 110b.

At 814, the first gNB 105a and the second gNB 105b may optionally perform a resource conflict check. The first gNB 105a may coordinate with the second gNB 105b (over the Xn interface link 125) to reserve the first resources for the first UE 110a and prevent other UEs, such as the second UE 110b, to utilize the first resources within the first coverage area 130a and the second coverage area 130b.

At 816, in optional implementations, if the second UE 110b is inactive (i.e., RRC INACTIVE), the second gNB 105b may page the second UE 110b and transmits RRC connection information to the second UE 110b. In an example, the second gNB 105b may transmit a RAN paging signal, using a second wireless communication link 135b, to the second UE 110b to wake up the second UE 110b. Next, the second gNB 105b may transmit RRC connection information to the second UE 110b so the second UE 110b may join the second cell served by the second gNB 105b.

At 818, in alternative implementations, the second UE 110b may transmit second sidelink UE information to the second gNB 105b via the second wireless communication link 135b. The second sidelink UE information may include one or more of L2 IDs of the first UE 110a and/or the second UE 110b, a bearer ID indicating the Quality of Service (QoS) for the requested sidelink communication, physical IDs of the first UE 110a and/or the second UE 110b, and/or other identifiers related to the first UE 110a, the second UE 110b, or the sidelink communication. The second sidelink UE information may also include a request to establish the V2V communication link 126 with the first UE 110a.

At 820, in optional implementations, the second gNB 105b may transmit second RRC connection reconfiguration information to the second UE 110b in response to the second sidelink UE information. The second RRC connection reconfiguration information may include configuration details for a sidelink signaling radio bearer, a sidelink data radio bearer, PSCCH information, PSFCH information, PSSCH information relating to the second cell, channel quality indicator (CQI) reports, sounding reference signals, antenna configurations, scheduling requests, and other information used by the second UE 110b to establish the V2V communication link 126.

At 822, in optional implementations, the second UE 110b may send a second BSR to the second gNB 105b to request second resources. The amount of resource elements in the second resources may be determined by the amount of data in the TX buffer of the second UE 110b, the available resources in the serving cell of the second gNB 105b, the types of data to be transmitted, or other relevant criteria.

At 824, in an optional implementation, in response to the second BSR, the second gNB 105b may transmit a second ePDCCH grant to the second UE 110b to allocate the second resources to the second UE 110b.

At 826, the second UE 110b may optionally transmit the second V2V message to the first UE 110a via the V2V communication link 126.

In some implementations, the first V2V message transmission 810 may occur before the peer UE search 812 and/or the resource conflict check 814 (as shown in FIG. 8). In other implementations, the first V2V message transmission 810 may occur after the peer UE search 812 and/or the resource conflict check 814. In certain examples, the first V2V message transmission 810 may not depend on the peer UE search 812 and/or the resource conflict check 814.

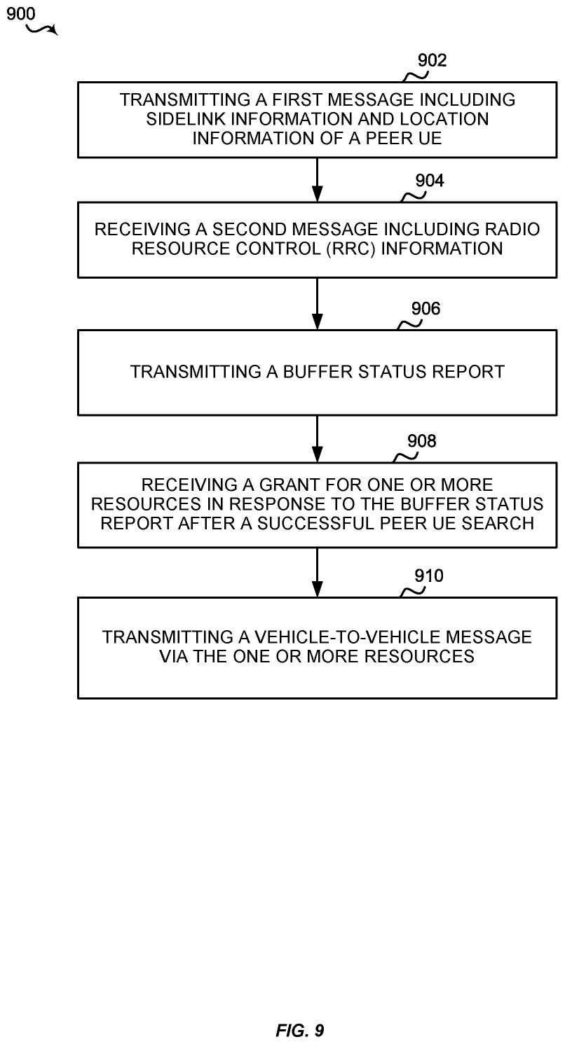

Turning now to FIG. 9, the communication component 150, the one or more processors 212, the modem 140, and/or the first UE 110a may perform an example of a method 900 of transmitting a V2V message.

At block 902, the method 900 may transmit a first message including sidelink information and location information of a peer UE. For example, the communication component 150 of the first UE 110a may transmit sidelink UE information and the location of the second UE 110b to establish the V2V communication link 126. The communication component 150 of the first UE 110a may send the sidelink information and/or location information to the transceiver 202 or the transmitter 208 of the first UE 110a. The transceiver 202 or the transmitter 208 may convert the data into electrical signals. The RF front end 288 may filter and/or amplify the electrical signals into the electro-magnetic signals. The one or more antennas 265 of the first UE 110a may transmit the electro-magnetic signals associated with the sidelink information and/or location information. Thus, the communication component 150, the transceiver 202, the transmitter 208, the RF front end 288, the one or more antennas 265, the modem 140, the one or more processors 212, and/or the first UE 110a or one of its subcomponents may define the means for transmitting the first message including sidelink information and location information of a peer UE. Additional details regarding transmitting the first message including sidelink information and location information of a peer UE are discussed above with reference to FIGS. 4-8.

At block 904, the method 900 may receive a second message including RRC information. For example, the communication component 150 of the first UE 110a may receive RRC connection reconfiguration information from the first gNB 105a. The one or more antennas 265 of the first UE 110a may receive electro-magnetic signals associated with the RRC connection reconfiguration information. The RF front end 288 of the first UE 110a may filter, amplify, and/or extract electrical signals carried by the electro-magnetic signals. The transceiver 202 or the receiver 206 of the first UE 110a may digitize and convert the electrical signals into data, such as the RRC connection reconfiguration information, and send to the communication component 150 of the first UE 110a. Thus, the communication component 150, the transceiver 202, the transmitter 208, the RF front end 288, the one or more antennas 265, the modem 140, the one or more processors 212, and/or the first UE 110a or one of its subcomponents may define the means for receiving the second message including RRC information. Additional details regarding receiving the second message including RRC information are discussed above with reference to FIGS. 4-8.

At block 906, the method 900 may transmit a buffer status report. For example, the communication component 150 of the first UE 110a may transmit a buffer status report to the first gNB 105a indicating the amount of resources requested. The communication component 150 of the first UE 110a may send the buffer status report to the transceiver 202 or the transmitter 208 of the first UE 110a. The transceiver 202 or the transmitter 208 may convert the data into electrical signals. The RF front end 288 may filter and/or amplify the electrical signals into the electro-magnetic signals. The one or more antennas 265 of the first UE 110a may transmit the electro-magnetic signals associated with the buffer status report. Thus, the communication component 150, the transceiver 202, the transmitter 208, the RF front end 288, the one or more antennas 265, the modem 140, the one or more processors 212, and/or the first UE 110a or one of its subcomponents may define the means for transmitting the buffer status report. Additional details regarding transmitting the buffer status report are discussed above with reference to FIGS. 4-8.

At block 908, the method 900 may receive a grant for one or more resources in response to the buffer status report after a successful peer UE search. For example, the communication component 150 of the first UE 110a may receive a grant for the resources requested in the buffer status report from the first gNB 105a after the first gNB 105a successfully performs the peer UE search in the first coverage area 130a and the neighboring coverage areas (via neighboring gNBs), such as the second coverage area 130b. The one or more antennas 265 of the first UE 110a may receive electro-magnetic signals associated with the grant for one or more resources. The RF front end 288 of the first UE 110a may filter, amplify, and/or extract electrical signals carried by the electro-magnetic signals. The transceiver 202 or the receiver 206 of the first UE 110a may digitize and convert the electrical signals into data, such as the grant for one or more resources, and send to the communication component 150 of the first UE 110a. Thus, the communication component 150, the transceiver 202, the transmitter 208, the RF front end 288, the one or more antennas 265, the modem 140, the one or more processors 212, and/or the first UE 110a or one of its subcomponents may define the means for receiving the grant. Additional details regarding receiving the grant are discussed above with reference to FIGS. 4-8.

At block 910, the method 900 may transmit a V2V message via the one or more resources. For example, the communication component 150 may transmit a V2V message using the granted resources. The communication component 150 of the first UE 110a may send the V2V message to the transceiver 202 or the transmitter 208 of the first UE 110a. The transceiver 202 or the transmitter 208 may convert the data into electrical signals. The RF front end 288 may filter and/or amplify the electrical signals into the electro-magnetic signals. The one or more antennas 265 of the first UE 110a may transmit the electro-magnetic signals associated with the V2V message. Thus, the communication component 150, the transceiver 202, the transmitter 208, the RF front end 288, the one or more antennas 265, the modem 140, the one or more processors 212, and/or the first UE 110a or one of its subcomponents may define the means for transmitting the V2V message. Additional details regarding transmitting the V2V message are discussed above with reference to FIGS. 4-8.

Certain implementations of the present disclosure may include any of the method above, wherein the sidelink information comprises at least one of a layer-2 identification of the UE, a layer-2 identification of the peer UE, a bearer identification, a physical layer identification of the UE, or a physical layer identification of the peer UE.

Some aspects of the present disclosure may include any of the method above, wherein the RRC information includes at least one of configuration details for a sidelink data radio bearer, Physical Sidelink Control Channel (PSCCH) information, Physical Sidelink Feedback Channel (PSFCH) information, Physical Sidelink Shared Channel (PSSCH) information, channel quality indicator (CQI) reports, sounding reference signals, antenna configurations, or scheduling requests.

Some examples of the present disclosure may include any of the method above, wherein receiving the grant for the one or more resources further comprises receiving the grant after a resource conflict check.

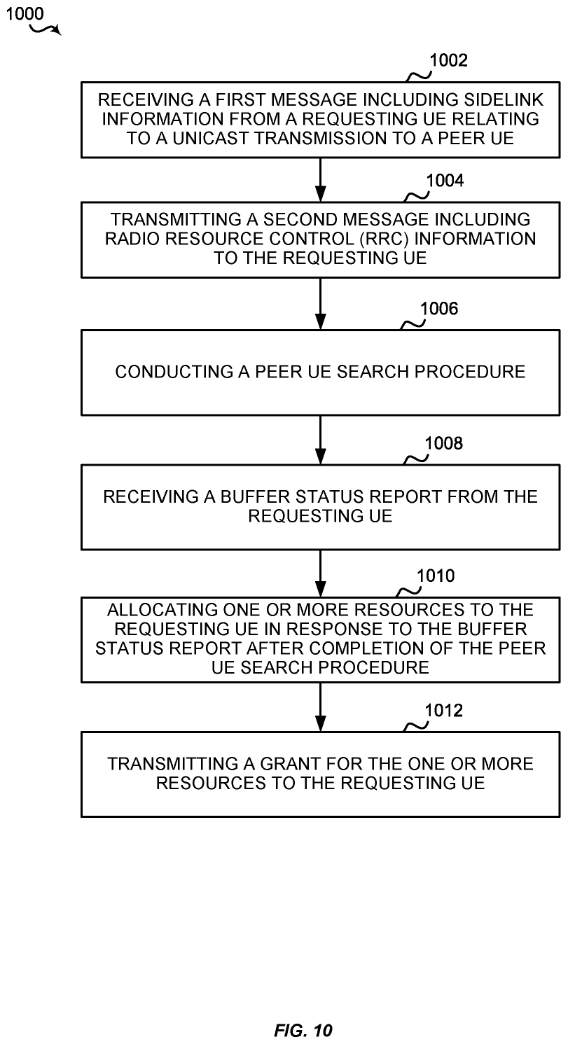

Turning now to FIG. 10, the communication component 170, the conflict component 172, the resource component 174, the one or more processors 312, the modem 160, and/or the first gNB 105a may perform an example of a method 1000 of performing a peer UE search.

At block 1002, the method 1000 may receive a first message including sidelink information from a requesting UE relating to a unicast transmission to a peer UE. For example, the communication component 170 of the first gNB 105a may receive sidelink UE information from the first UE 110a to establish the V2V communication link 126 with the second UE 110b. The one or more antennas 365 of the gNB 105a may receive electro-magnetic signals associated with the sidelink information. The RF front end 388 of the gNB 105a may filter, amplify, and/or extract electrical signals carried by the electro-magnetic signals. The transceiver 302 or the receiver 306 of the gNB 105a may digitize and convert the electrical signals into data, such as the sidelink information, and send to the communication component 170 of the gNB 105a. Thus, the communication component 170, the transceiver 302, the transmitter 308, the RF front end 388, the one or more antennas 365, the modem 160, the one or more processors 312, and/or the first gNB 105a or one of its subcomponents may define the means for receiving the sidelink information from a requesting UE relating to a unicast transmission to a peer UE. Additional details regarding receiving the sidelink information from a requesting UE relating to a unicast transmission to a peer UE are discussed above with reference to FIGS. 4-8.

At block 1004, the method 1000 may transmit a second message including RRC information to the requesting UE. For example, the communication component 170 of the first gNB 105a may transmit RRC connection reconfiguration information to the first UE 110a. The communication component 170 of the gNB 105a may send the RRC information to the transceiver 302 or the transmitter 308 of the gNB 105a. The transceiver 302 or the transmitter 308 may convert the data into electrical signals. The RF front end 388 may filter and/or amplify the electrical signals into the electro-magnetic signals. The one or more antennas 365 of the gNB 105a may transmit the electro-magnetic signals associated with the RRC information. Thus, the communication component 170, the transceiver 302, the transmitter 308, the RF front end 388, the one or more antennas 365, the modem 160, the one or more processors 312, and/or the first gNB 105a or one of its subcomponents may define the means for transmitting the RRC information. Additional details regarding transmitting the RRC information are discussed above with reference to FIGS. 4-8.

At block 1006, the method 1000 may conduct a peer UE search procedure. For example, the conflict component 172, the modem 160, and/or the one or more processors 312 may conduct a peer UE search procedure in the first coverage area 130a and the neighboring coverage areas (via neighboring gNBs), such as the second coverage area 130b. Thus, the conflict component 172, the modem 160, and/or the one or more processors 312, and/or the first gNB 105a or one of its subcomponents may define the means for conducting the peer UE search procedure. Additional details regarding conducting the peer UE search procedure are discussed above with reference to FIGS. 4-8.

At block 1008, the method 1000 may receive a buffer status report from the requesting UE. For example, the communication component 170 of the first gNB 105a may receive a buffer status report from the first UE 110a indicating the amount of resources requested. The one or more antennas 365 of the gNB 105a may receive electro-magnetic signals associated with the buffer status report. The RF front end 388 of the gNB 105a may filter, amplify, and/or extract electrical signals carried by the electro-magnetic signals. The transceiver 302 or the receiver 306 of the gNB 105a may digitize and convert the electrical signals into data, such as the buffer status report, and send to the communication component 170 of the gNB 105a. Thus, the communication component 170, the transceiver 302, the receiver 306, the RF front end 388, the one or more antennas 365, the modem 160, the one or more processors 312, and/or the first gNB 105a or one of its subcomponents may define the means for receiving the buffer status report. Additional details regarding receiving the buffer status report are discussed above with reference to FIGS. 4-8.

At block 1010, the method 1000 may allocate one or more resources to the requesting UE in response to the buffer status report after completion of the peer UE search procedure. For example, the resource component 174, the modem 160, and/or the one or more processors 312 of the first gNB 105a may allocate resources to the first UE 110a. The amount of resources allocated may be determined by the amount of data requested in the buffer status report, availability of resources in the first coverage area 130a, and other factors. Thus, the resource component 174, the modem 160, and/or the one or more processors 312, and/or the first gNB 105a or one of its subcomponents may define the means for allocating the one or more resources. Additional details regarding allocating the one or more resources are discussed above with reference to FIGS. 4-8.

At block 1012, the method 1000 may transmit a grant for one or more resources to the requesting UE. For example, the communication component 170 of the first gNB 105a may transmit a grant for one or more resources to the first UE 110a. The communication component 170 of the gNB 105a may send the grant to the transceiver 302 or the transmitter 308 of the gNB 105a. The transceiver 302 or the transmitter 308 may convert the data into electrical signals. The RF front end 388 may filter and/or amplify the electrical signals into the electro-magnetic signals. The one or more antennas 365 of the gNB 105a may transmit the electro-magnetic signals associated with the grant. Thus, the communication component 170, the transceiver 302, the transmitter 308, the RF front end 388, the one or more antennas 365, the modem 160, the one or more processors 312, and/or the first gNB 105a or one of its subcomponents may define the means for transmitting the grant. Additional details regarding transmitting the grant are discussed above with reference to FIGS. 4-8.

Certain implementations of the present disclosure may include any of the method above locating the peer UE within a coverage area of the BS and reserving the one or more resources exclusively for the requesting UE in the coverage area of the BS.

Some aspects of the present disclosure may include any of the method above, wherein conducting the peer UE search procedure includes coordinating with a neighboring BS to locate the peer UE within a neighboring coverage area of the neighboring BS and reserve the one or more resources exclusively for the requesting UE in the coverage area of the neighboring BS and a local coverage area of the BS.

Certain examples of the present disclosure may include any of the method above, wherein conducting the peer UE search procedure includes coordinating with a neighboring BS to transmit a radio access network paging signal from the neighboring BS to the peer UE.

Certain implementations of the present disclosure may include any of the method above, wherein the sidelink information includes at least one of a layer-2 identification of the UE, a layer-2 identification of the peer UE, a bearer identification, a physical layer identification of the UE, or a physical layer identification of the peer UE.

Some aspects of the present disclosure may include any of the method above, wherein the RRC information includes at least one of configuration details for a sidelink data radio bearer, Physical Sidelink Control Channel (PSCCH) information, Physical Sidelink Feedback Channel (PSFCH) information, Physical Sidelink Shared Channel (PSSCH) information, channel quality indicator (CQI) reports, sounding reference signals, antenna configurations, or scheduling requests.

Certain examples of the present disclosure may include any of the method above, wherein receiving the grant for the one or more resources further comprises receiving the grant after a resource conflict check.

Certain implementations of the present disclosure may include any of the method above, wherein the base station is a gNB.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by a user equipment (UE), comprising:
transmitting a first message including sidelink information and location information of a peer UE to a base station (BS);
receiving a second message including radio resource control (RRC) information from the BS;
transmitting a buffer status report to the BS;
receiving a grant for one or more resources in response to the buffer status report after a successful peer UE search from the BS; and
transmitting a vehicle-to-vehicle message to the peer UE via the one or more resources.

2. The method of claim 1, wherein the sidelink information includes at least one of a layer-2 identification of the UE, a layer-2 identification of the peer UE, a bearer identification, a physical layer identification of the UE, or a physical layer identification of the peer UE.

3. The method of claim 1, wherein the RRC information includes at least one of configuration details for a sidelink signaling radio bearer, a sidelink data radio bearer, Physical Sidelink Control Channel (PSCCH) information, Physical Sidelink Feedback Channel (PSFCH) information, Physical Sidelink Shared Channel (PSSCH) information, channel quality indicator (CQI) reports, sounding reference signals, antenna configurations, or scheduling requests.

4. The method of claim 1, wherein receiving the grant for the one or more resources further comprises receiving the grant after performing a resource conflict check.

5. A user equipment (UE), comprising
a memory;
a transceiver; and
one or more processors operatively coupled with the memory and the transceiver, the one or more processors being configured to:
transmit, via the transceiver, a first message including sidelink information and location information of a peer UE to the base station (BS);
receive, via the transceiver, a second message including radio resource control (RRC) information from the BS;
transmit, via the transceiver, a buffer status report to the BS;
receive, via the transceiver, a grant for one or more resources in response to the buffer status report after a successful peer UE search from the BS; and
transmit, via the transceiver, a vehicle-to-vehicle message to the peer UE via the one or more resources.

6. The UE of claim 5, wherein the sidelink information includes at least one of a layer-2 identification of the UE, a layer-2 identification of the peer UE, a bearer identification, a physical layer identification of the UE, or a physical layer identification of the peer UE.

7. The UE of claim 5, wherein the RRC information includes at least one of configuration details for a sidelink data radio bearer, Physical Sidelink Control Channel (PSCCH) information, Physical Sidelink Feedback Channel (PSFCH) information, Physical Sidelink Shared Channel (PSSCH) information, channel quality indicator (CQI) reports, sounding reference signals, antenna configurations, or scheduling requests.

8. The UE of claim 5, wherein receiving the grant for the one or more resources further comprises receiving the grant after performing a resource conflict check.

9. A non-transitory computer-readable medium having instructions stored therein that, when executed by one or more processors of a user equipment (UE), cause the one or more processors to:
transmit a first message including sidelink information and location information of a peer UE to a base station (BS);
receive a second message including radio resource control (RRC) information from the BS;
transmit a buffer status report to the BS;
receive a grant for one or more resources in response to the buffer status report after a successful peer UE search from the BS; and
transmit a vehicle-to-vehicle message to the peer UE via the one or more resources.

10. The non-transitory computer-readable medium of claim 9, wherein the sidelink UE information includes at least one of a layer-2 identification of the UE, a layer-2 identification of the peer UE, a bearer identification, a physical layer identification of the UE, or a physical layer identification of the peer UE.

11. The non-transitory computer-readable medium of claim 9, wherein the RRC connection reconfiguration information includes at least one of configuration details for a sidelink data radio bearer, Physical Sidelink Control Channel (PSCCH) information, Physical Sidelink Feedback Channel (PSFCH) information, Physical Sidelink Shared Channel (PSSCH) information, channel quality indicator (CQI) reports, sounding reference signals, antenna configurations, or scheduling requests.

12. The non-transitory computer-readable medium of claim 9, wherein receiving the grant for the one or more resources further comprises receiving the grant after a resource conflict check.

13. A method of wireless communication by a base station (BS), comprising:
receiving a first message including sidelink information from a requesting user equipment (UE) relating to a unicast transmission to a peer UE;
transmitting a second message including radio resource control (RRC) information to the requesting UE;
conducting a peer UE search procedure;
receiving a buffer status report from the requesting UE;
allocating one or more resources to the requesting UE in response to the buffer status report after completion of the peer UE search procedure; and
transmitting a grant for the one or more resources to the requesting UE.

14. The method of claim 13, wherein conducting the peer UE search procedure includes:
locating the peer UE within a coverage area of the BS; and
reserving the one or more resources exclusively for the requesting UE in the coverage area of the BS.

15. The method of claim 13, wherein conducting the peer UE search procedure includes coordinating with a neighboring BS to:
locate the peer UE within a neighboring coverage area of the neighboring BS; and
reserve the one or more resources exclusively for the requesting UE in the coverage area of the neighboring BS and a local coverage area of the BS.

16. The method of claim 13, wherein conducting the peer UE search procedure includes coordinating with a neighboring BS to transmit a radio access network paging signal from the neighboring BS to the peer UE.

17. The method of claim 13, wherein the sidelink information includes at least one of a layer-2 identification of the UE, a layer-2 identification of the peer UE, a bearer identification, a physical layer identification of the UE, or a physical layer identification of the peer UE.

18. The method of claim 13, wherein the RRC information includes at least one of configuration details for a sidelink data radio bearer, Physical Sidelink Control Channel (PSCCH) information, Physical Sidelink Feedback Channel (PSFCH) information, Physical Sidelink Shared Channel (PSSCH) information, channel quality indicator (CQI) reports, sounding reference signals, antenna configurations, or scheduling requests.

19. The method of claim 13, wherein receiving the grant for the one or more resources further comprises receiving the grant after a resource conflict check.

20. The method of claim 13, wherein the base station is a gNB.
